(19) United States
(12) Patent Application Publication
(10) Pub. No.: US 2018/0324907 A1
(43) Pub. Date: Nov. 8, 2018

(54) FOOD TREATMENT DEVICE

(71) Applicant: BSH Hausgeräte GmbH, Munich (DE)

(72) Inventors: Joschka Bär, Traunstein (DE); Peter Mallinger, Traunreut (DE); Philipp Ruzanski, Freiburg im Breisgau (DE); Günter Zschau, Traunwalchen (DE)

(21) Appl. No.: 15/773,175

(22) PCT Filed: Nov. 29, 2016
(86) PCT No.: PCT/EP2016/079131

§ 371 Date: May 3, 2018

(30) Foreign Application Priority Data
Dec. 18, 2015 (DE) 10 2015 225 992.7

(51) Int. Cl. H05B 6/64; F24C 15/00; F21V 8/00

(52) U.S. Cl. CPC H05B 6/6444; G02B 6/0008; F24C 15/008

(57) ABSTRACT

A food treatment appliance includes a muffle having a muffle interior. Arranged outside the muffle is a light-generating facility for radiating light into the muffle interior through an opening in the muffle. A light-distributing element is arranged in the muffle interior and configured to distribute light radiating in through the opening The light-generating facility and the light-distributing element are arranged such as to define a gap there between. The food treatment appliance can be applied to cooking devices having an oven functionality and/or microwave functionality.

The invention relates to a food treatment appliance, having a muffle interior enclosed by a muffle and a light-generating facility arranged outside the muffle for radiating light into the muffle interior through an opening in the muffle. The invention can in particular be advantageously applied to cooking appliances with an oven functionality and/or microwave functionality.

DE 10 2012 223 465 A1 discloses a cooking appliance with a cooking appliance muffle and a light source arranged outside the muffle for lighting the muffle interior through an opening in a muffle wall, the light source being arranged below the opening and at least one optical element being provided to deflect the beam of light from the light source into the muffle interior.

DE 10 2012 223 678 A1 discloses a lighting apparatus for a cooking chamber of a cooking appliance, comprising at least one light source and at least one light guide. The at least one light guide is shown as an elongated element and at least one structured region incorporating at least one structure is provided on at least one part of the periphery of the light guide. A cooking appliance with a lighting apparatus is also described.

DE 10 2005 005 267 A1 discloses an apparatus for heating food with a housing wall, which defines a cooking chamber, and a lighting facility for the cooking chamber, having a light source with at least one light outlet opening and a diffuser, preferably a diffusing panel or plate, made of a temperature-resistant material, adjoining the light outlet opening to diffuse light from the light source into the cooking chamber.

DE 10 2013 005 988 A1 discloses an electric domestic appliance, specifically a refrigerator and/or freezer or oven, with at least one light panel lighting an interior of the appliance and a light source apparatus coupling light into the light panel on at least one of its narrow faces. The light source apparatus has at least one light-emitting diode and a lens system, which brings together at least a majority of the light emitted by the light-emitting diode and directs it onto at least one narrow face of the light panel.

It is the object of the present invention to at least partially eliminate the disadvantages of the prior art and in particular to provide an improvement.

This object is achieved according to the features of the independent claims. Preferred embodiments will emerge in particular from the dependent claims.

The object is achieved by a food treatment appliance, having a muffle interior enclosed by a muffle and a light-generating facility arranged outside the muffle for radiating light into the muffle interior through an opening in the muffle, a light-distributing element for distributing light that can be radiated in through the opening being arranged in the muffle interior and a gap being present between the light-generating facility and the light-distributing element.

It is one advantage of this food treatment appliance that adjustments can be made in a particularly simple manner for different—in particular also functional—configurations of the food treatment appliance (for example with or without microwave function), as a light-emitting region of the light-generating facility is not connected to the muffle in a fixed manner but is at a distance therefrom. This in particular assists a functionally modular structure of the food treatment appliance. The light-generating facility can be a prefabricated module. Lighting can also be brought about particularly economically and in a manner that is less affected by tolerances due to the greater mechanical decoupling of the light-generating facility from the muffle. It also means that there is no need to clamp the light-generating facility during assembly.

In one development the food treatment appliance is a domestic appliance. The food treatment appliance can generally be a cooking appliance for cooking or heat-treating food. The food treatment appliance in particular has an oven or is an oven. The food treatment appliance can have a steam cooking functionality and/or a microwave functionality, together with or without an oven functionality.

A muffle generally refers to a housing or wall, which delimits the muffle interior. The muffle interior can also be referred to as a food treatment chamber or—in the case of an oven—an oven chamber and serves to treat food present in the muffle interior. If the treatment chamber is an oven chamber, the muffle can also be referred to as an oven muffle.

The light-generating facility is in particular not connected directly to the muffle.

The light-generating facility can have one or more light sources, for example LEDs, for generating the light, which can be radiated into the muffle interior through the opening (which can also be referred to as an aperture).

In one development the opening is located in the gap between the light-generating facility and the light-distributing element and therefore the light guiding facility ends in front of the opening and the light-distributing element is accommodated in its entirety in the muffle interior. This allows particularly simple mechanical decoupling of muffle and light-generating facility.

Alternatively the gap can be located in its entirety within the muffle interior. The light-guiding facility can then also reach or project into or through the opening into the muffle interior, while the light-distributing element is accommodated in its entirety in the muffle interior.

Alternatively the gap can be located in its entirety outside the muffle interior. The light-distributing element can then reach into the opening or project outward through the opening, while the light-guiding facility is located in its entirety outside the muffle interior.

The opening can have a single aperture or a number of apertures (for example a number of slits or round holes). For example the round holes can have a diameter between 0.5 mm and 10 mm (in particular 5+−0.5 mm).

In one configuration the light-generating facility has a light-guiding facility for guiding the light generated by it to the opening, the light-guiding facility ending in front of the opening. This allows the light to be guided specifically to the opening so that its loss of light up to the opening is minimal and the light-guiding facility can also be mechanically decoupled from the muffle in a simple manner.

In an alternative or additional development the light-generating facility has a light-guiding facility for guiding the light generated by it to the opening, the light-guiding facility projecting into the opening or projecting through the opening into the muffle. This allows light loss to be prevented particularly effectively.

In one development the light-guiding facility has a light guide or light wave guide or is such, guiding light coupled in at an—in particular end—light inlet surface by means of total internal reflection to an—in particular end—light outlet surface and coupling it out there. The light guide can be just one light guide or can have a number of light guides. The light guide can in particular be shaped in the manner of a bar. Alternatively the light guide can be at least one hollow, internally mirrored tube or solid body or the like, which can also be referred to in the following as a “light guiding channel”.

The light guide can be made of plastic. The light guide is advantageously made of glass, as glass is particularly thermally resistant.

In one configuration the light-generating facility ends in front of the opening and the food treatment appliance has a reflector, which laterally encloses a region between the light-generating facility, in particular its light-guiding facility, and the opening. The light emitted by the light-guiding facility therefore passes through the spatial region enclosed by the reflector to the opening. This reduces or even prevents light loss, which would otherwise result with light radiated by the light-guiding facility adjacent to the opening or reflected by the opening (for example an edge thereof). The reflector also prevents insulating material passing between the light outlet surface of the light-generating facility and the opening. The reflector can also be used to aid assembly, particularly incorporation, when assembling the light-generating facility.

In one development the reflector is shaped in the manner of a funnel and the light-generating facility, in particular its light-guiding facility, for example enters its narrower aperture and the wider aperture of the reflector adjoins the opening. The reflector therefore widens out from the light-generating facility, in particular its light-guiding facility, toward the opening. This is particularly advantageous if a light outlet surface of the light-guiding facility is smaller than a surface of the opening. If a light outlet surface of the light-guiding facility is larger than a surface of the opening, the reflector can narrow from the light-guiding facility to the opening.

In another configuration the reflector is connected in a fixed manner to the muffle and has an insertion aperture for the light-generating facility, in particular its light-guiding facility. This has the advantage that the light-generating facility, in particular its light-guiding facility, can be arranged particularly easily on the—for example funnel-shaped—reflector. With this configuration the reflector can also be seen as an external attachment or fronting element for the opening. The insertion aperture can enclose light-generating facility, in particular its light-guiding facility, in a close or distant manner. In particular a lateral gap between them does not allow the passage of microwaves.

In one development the insertion aperture can be widened elastically. This allows a close fit for the light-generating facility, in particular its light-guiding facility. It also allows light loss to be kept particularly minimal. The insertion aperture can also have for example at least one resilient flap.

In another configuration the opening is covered by a cover element. This prevents unwanted passage of material and/or radiation outward through the opening out of the muffle interior and/or from outside into the muffle interior in a particularly reliable manner. The fact that the opening is covered by the cover element can mean in particular that the cover element is a separately produced element, which is inserted into the opening and/or positioned on the opening. The cover element can in particular reduce or even completely prevent passage of air and/or radiation from a spectral range outside the light that can be radiated in. This configuration has the further advantage that a, for example large, opening in the muffle can be adjusted for desired functionalities of the food treatment appliance by the cover element with little outlay, thus providing further improved modularity.

In a further configuration the cover element has or is a light-permeable panel. This has the advantage that the light generated by the light-generating facility can penetrate through the panel into the muffle interior practically without loss but heat, vapor, steam, etc. present in the muffle interior cannot leave the muffle. The panel is advantageously transparent to prevent light loss. The panel can be made of glass or silicone for example.

In an alternative or additional configuration the cover element has or is a light-permeable metal cover element. Light permeability can be provided for example by breaks or holes in the cover element. Such a cover element has the advantage that it can be used as a microwave seal. The light generated by the light-generating facility can pass through the microwave seal into the muffle interior but microwave radiation cannot leave the muffle. The microwave-proof cover element is in particular also connected electrically to the muffle, in order for example to make it more microwave-proof.

The metal light-permeable cover element can be or have for example a perforated plate or a metal mesh or metal web. The light generated by the light-generating facility can then pass for example through the holes in the perforated plate or through gaps in the metal mesh into the muffle interior. The perforated plate can be a perforated sheet. The size and density of the holes can be selected for example to tailor the perforated plate for the microwave radiation. The perforated sheet can be configured as a metal film, the thickness of which is smaller than a wall thickness of the muffle, allowing a particularly high degree of freedom of configuration in respect of the density of the holes. The metal mesh can be present in the form of a mat.

The cover element can be a multilayer element, for example having one layer in the form of a transparent silicone plate and one layer in the form of a perforated plate.

Alternatively or additionally the opening formed or integrated in the muffle is microwave-proof, for example due to the provision of a number of round holes, in particular with a diameter between 0.5 mm and 10 mm (specifically 5+−0.5 mm).

In another configuration one of the side walls of the muffle has an outward facing depression, in which the opening is located, and the light-generating facility is arranged such that its main emission direction is parallel to the side wall of the muffle having the depression. This has the advantage that the food treatment appliance can have a particularly compact structure and also a particularly large area of light radiation can be achieved from the depression into the remainder of the muffle interior with simple means. A main emission direction can refer to a direction of the light component generated by the light-generating facility with the highest light intensity or light density. A main emission direction can also refer to a direction along an axis of symmetry of the light cone emitted by the light-generating facility. The depression can also be referred to as a bulge. The fact that the main emission direction is aligned parallel to the side wall of the muffle can mean in particular that it lies in a vertical plane.

In yet another configuration the depression is an elongated depression, which is incorporated in a vertically aligned wall (in other words in a left-hand side wall, a right-hand side wall and/or the rear wall) of the muffle and is aligned vertically, horizontally or at an angle there. Because the depression is an elongated depression, light can advantageously be radiated in a particularly high or wide manner into the remainder of the muffle interior. Its horizontal alignment advantageously allows homogeneous, wide lighting of an insertion level (at its level or at the level of an associated food). Vertical alignment of the depression advantageously allows homogeneous lighting of a number of insertion levels.

In one development the depression has a rectangular top surface and an adjoining side surface connecting the top surface to the right-hand side wall and the opening is located in the side surface. This allows particularly easy incorporation of the depression, for example by deep drawing, and a particularly compact structure. In particular the light can be radiated into the muffle without beam deflection, for example by means of a straight light-guiding facility, even when the light is guided parallel to the associated side wall of the muffle.

In a further configuration the light-distributing element is arranged in the depression and can be radiated with the light through the opening. This has the advantage that the light-distributing element does not compete with the region of the muffle interior provided to accommodate the food. The light-distributing element can in particular be arranged in its entirety in the depression. The light-distributing element can be radiated in particular directly through the opening, for example without an intermediate optical deflection element. The light-distributing element can thus be arranged in particular in a direct line of sight from the light outlet surface of the light-generating facility through the opening. This configuration can also achieve the object on its own. Said object is also achieved by a food treatment appliance having a muffle interior enclosed by a muffle and a light-generating facility arranged outside the muffle for radiating light into the muffle interior through an opening in the muffle, a light-distributing element for distributing light that can be radiated in through the opening being arranged in the muffle interior, the muffle having an outward facing depression, in which the depression is located, in one of its side walls and the light-distributing element being arranged in the depression and being able to be radiated with the light through the opening.

In a further configuration the light-distributing element is an optical transmitted light element that shields the depression from the remainder of the muffle interior. This protects the depression to a greater degree from the penetration of vapor, steam, microwave radiation, etc.

In yet another configuration the light-distributing element has a rear face facing away from the muffle interior and having a lighting surface that can be lit by the light radiated in. This food treatment appliance has the advantage that the light-distributing element can be produced and incorporated in the muffle in a particularly simple and compact manner. To cover the depression, the light-distributing element has an outer contour matched to the depression. The light-distributing element can be for example screwed, latched, clamped, plugged, bonded, etc. to the muffle.

In a further configuration the light-distributing element has an in particular stepped surface structure on its lighting surface. This advantageously deflects the light radiated in to a significant degree locally in a small space. In particular it allows the light-distributing element to be kept particularly narrow.

In one development the surface structure is configured such that a light beam striking the lighting surface is deflected downward at an angle, in other words into a half space below a horizontal plane, in which plane a light outlet point of a pertaining light beam is located. This has the advantage that food present in the muffle interior can be lit particularly effectively.

In a further configuration the light-distributing element has an elongated lighting surface that is curved over its longitudinal extension. The curvature is advantageously parabolic in cross section. For example the steps can be arranged one behind the other on a parabolic contour. In particular the entire rear face, in particular the entire light-distributing element, can be curved along its longitudinal extension, allowing particularly constant lighting over its length.

In a further configuration the light-distributing element has an elongated lighting surface that is curved over its transverse extension. The curvature can in particular be curved in a circular manner in cross section. Steps here can have a curved shape or transverse extension for example.

In a further configuration the depression, in particular its top surface, is covered at least partially by a reflector element on the inside. This reduces light loss due to light emitted backward at the light-distributing element or radiated out of the muffle interior onto the light-distributing element, as such light is thrown back at the reflector element and can then re-enter the muffle interior, for example through the light-distributing element. The reflector element can be a reflector sheet. The reflector element, in particular reflector sheet, can be polished to reflect and/or be coated with a reflective or diffusively reflecting reflective layer.

In one development that advantageously enhances lighting efficiency the light-distributing element is at least partially printed.

The food treatment appliance described above has inter alia one or more of the following advantages: a dedicated microwave seal is no longer needed or a simpler microwave seal than hitherto can be used. Lighting efficiency is enhanced, in particular if light is only radiated downward into the muffle interior (for example due to the zig-zag surface structure). A modular structure (oven, pyrolysis, microwave, steam, etc.) is supported. The decoupling of the light guide from the muffle allows the design to be particularly unaffected by tolerances. Heating due to microwave radiation is also reduced in the depression. The light guide can also be configured more simply (for example shorter, without printing, no phase, thicker, etc.). Also standardization with a holder and a light guide of a top light of the muffle is also simplified or made possible. The reflector sheet can also be simplified (for example with embossing, flaps, bolts). The problem of clamping light guides that arose hitherto during assembly is eliminated. Costs are reduced (for example relating to a microwave seal, reflector, light guide, holder, assembly, etc.).

The characteristics, features and advantages of the present invention as described above and the manner in which these are achieved will become clearer and easier to understand in conjunction with the following schematic description of an exemplary embodiment, which is explained in more detail in conjunction with the drawings, in which:

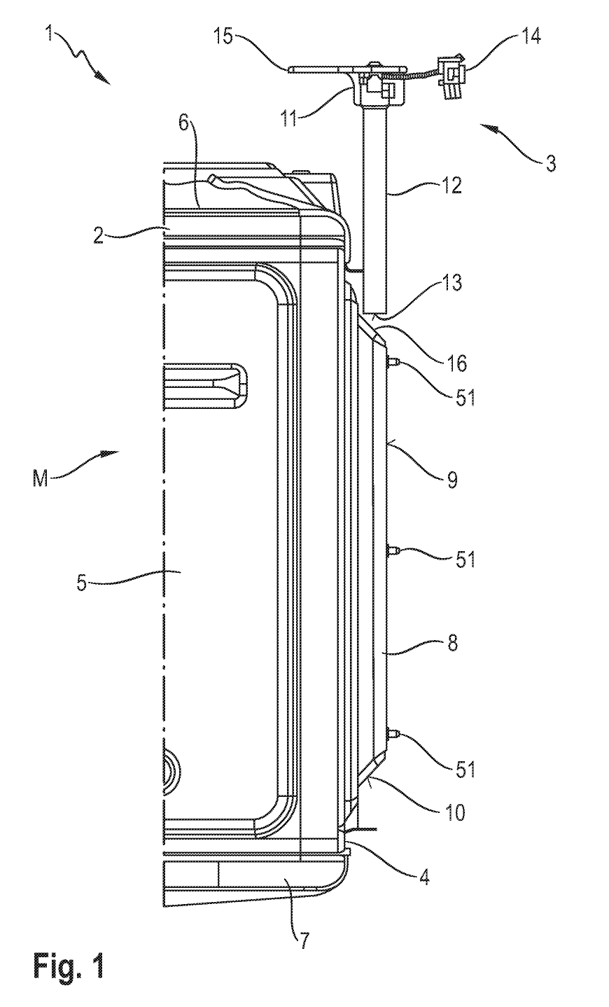

FIG. 1 shows a detail of a side view of a muffle of a cooking appliance according to a first exemplary embodiment together with a light-generating facility of the cooking appliance;

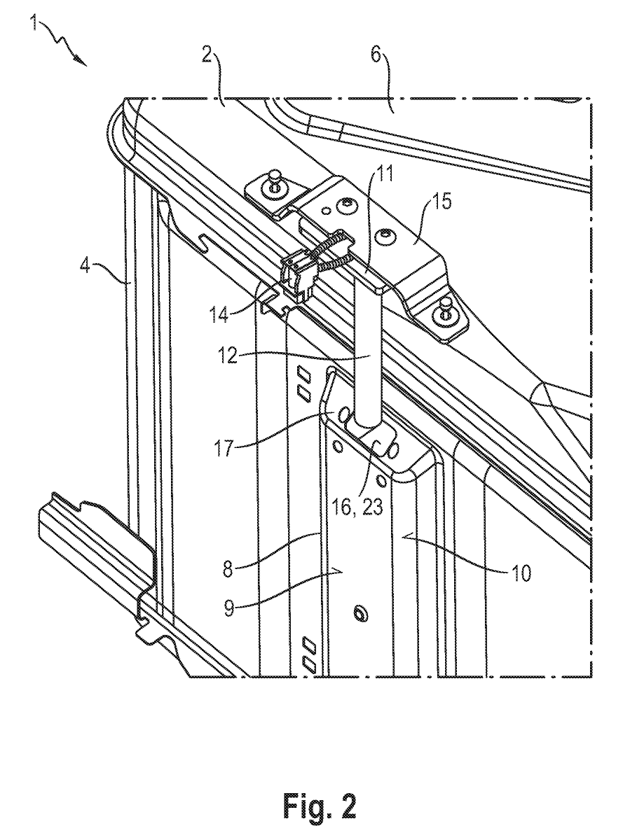

FIG. 2 shows a shows a detail of the components from FIG. 1 viewed from above at an angle to a lateral region of the muffle;

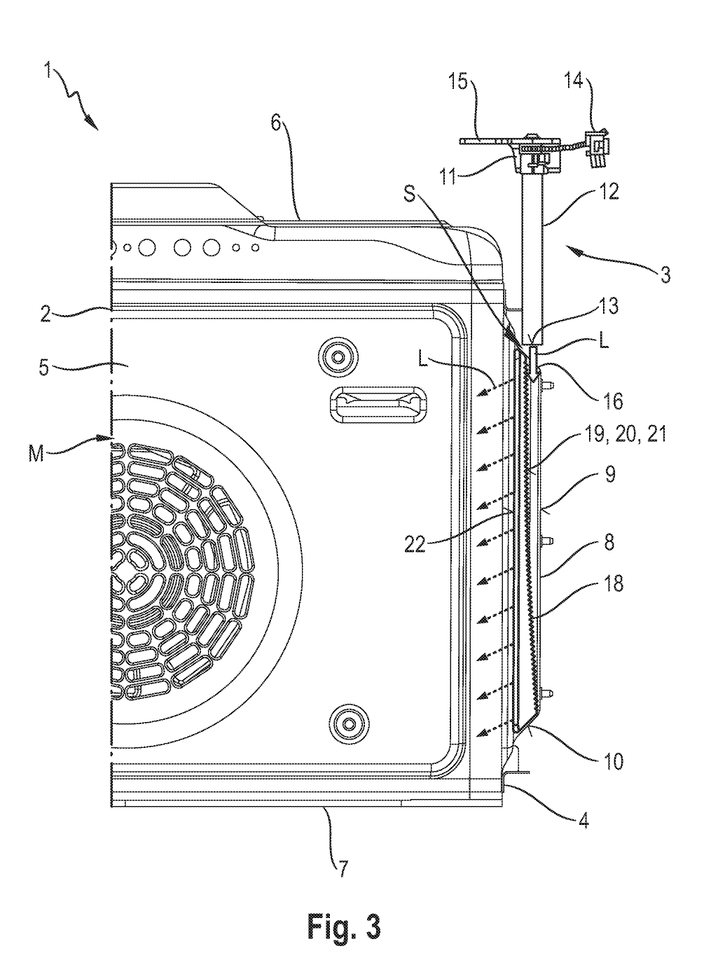

FIG. 3 shows a detail of a side view of the muffle of the cooking appliance according to the first exemplary embodiment shown as semi-transparent together with a light-distributing element accommodated in the muffle and the light-generating facility;

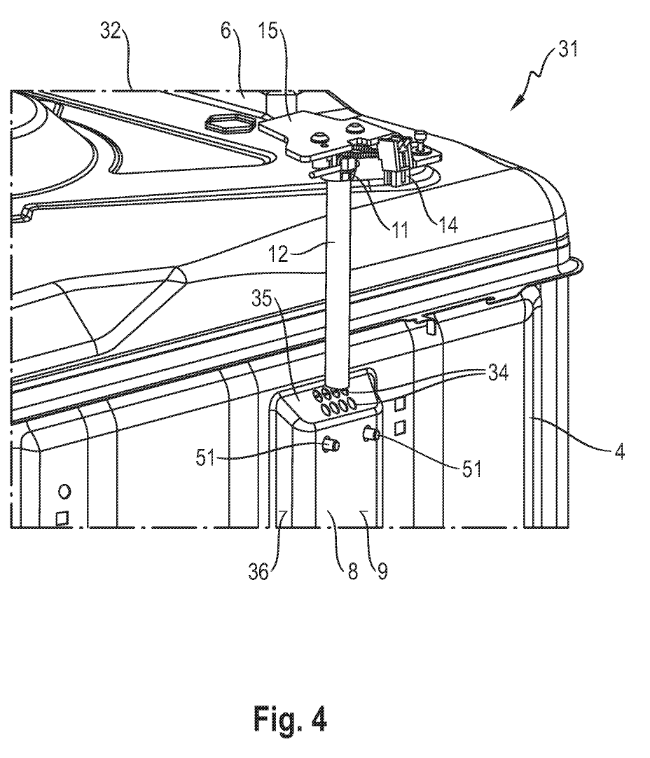

FIG. 4 shows a detail viewed at an angle from above of a lateral region of the muffle of a cooking appliance according to a second exemplary embodiment together with a light-generating facility of this cooking appliance;

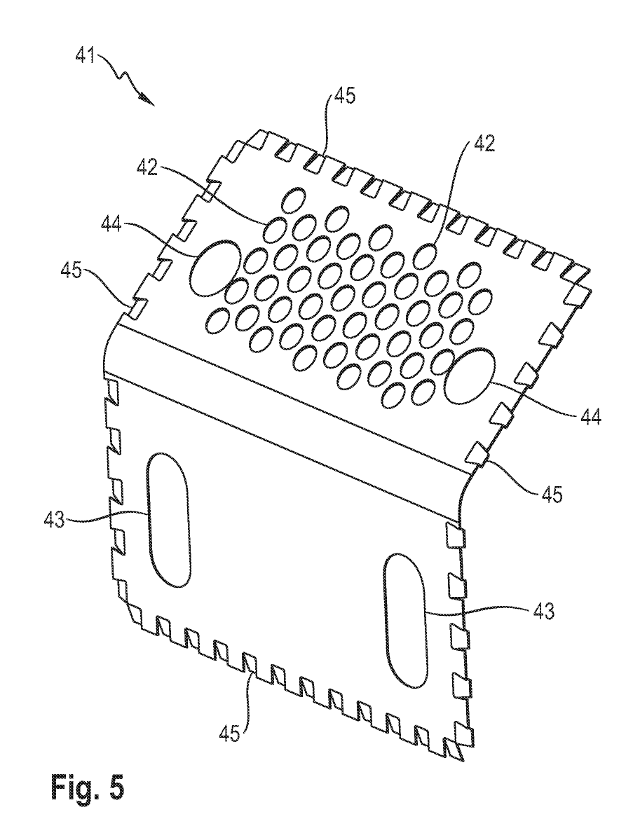

FIG. 5 shows a cover element for the cooking appliance according to the first exemplary embodiment viewed at an angle from above;

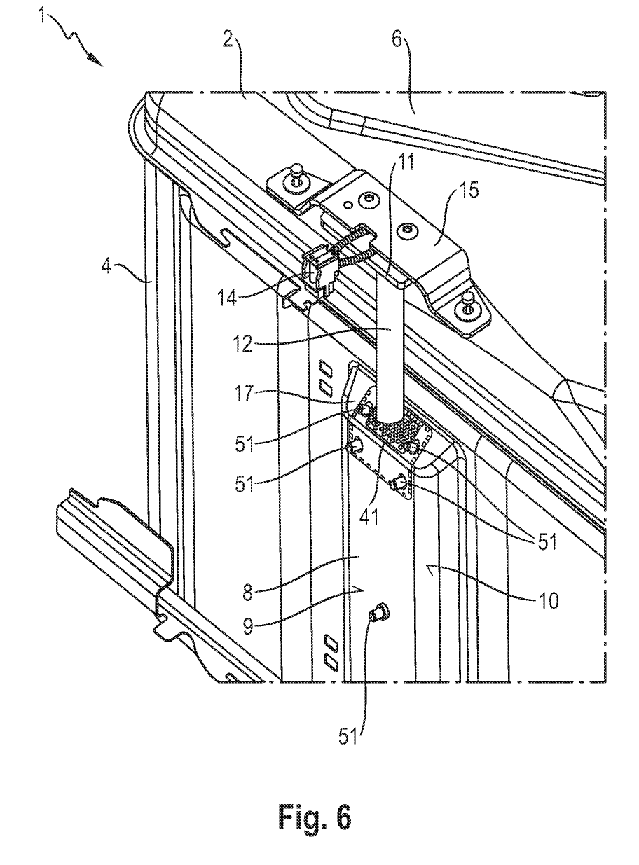

FIG. 6 shows a detail viewed at an angle from above of a lateral region of the muffle of the cooking appliance according to the first exemplary embodiment with the cover element from FIG. 5 in place;

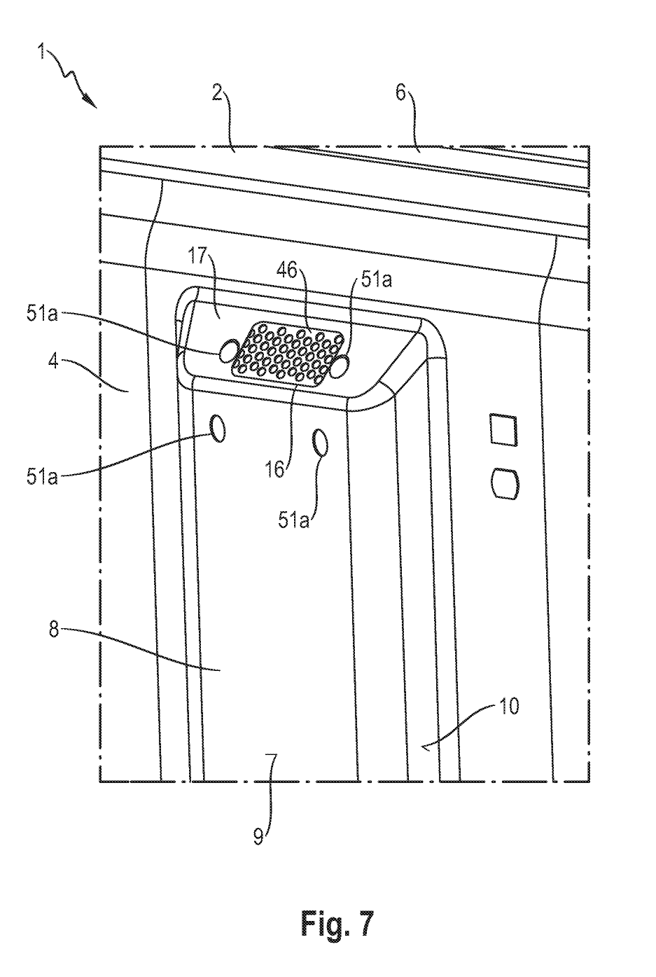

FIG. 7 shows a detail viewed at an angle from above of the lateral region of the muffle of the cooking appliance according to the first exemplary embodiment with a different cover element fitted thereon;

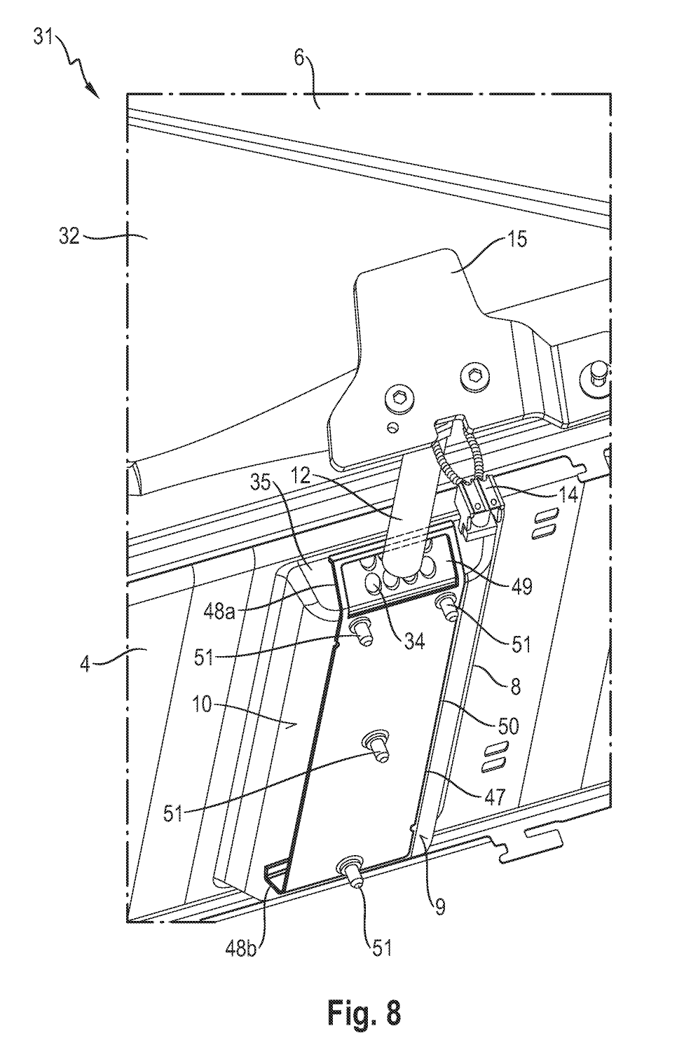

FIG. 8 shows a detail viewed at an angle from above of a lateral region of the muffle of the cooking appliance according to the second exemplary embodiment shown as semi-transparent with a reflector element accommodated therein;

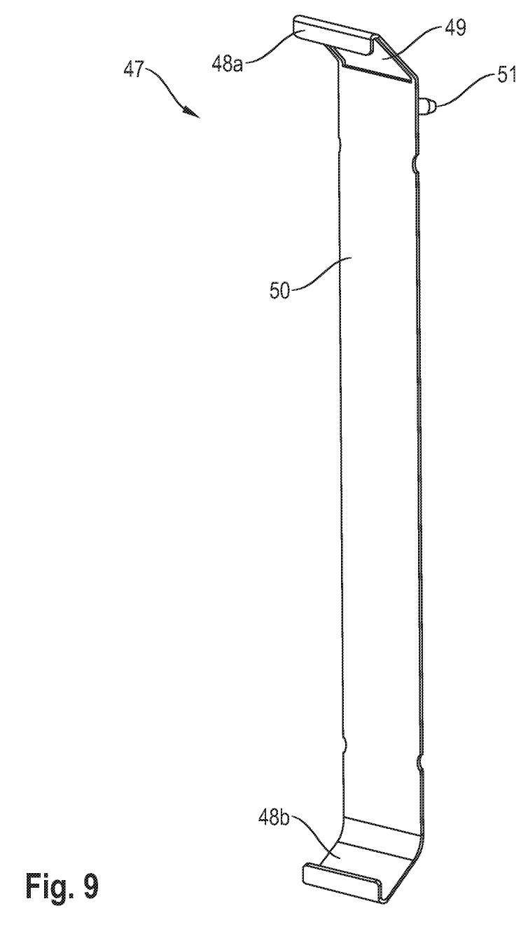

FIG. 9 shows the reflector element from FIG. 8 viewed at an angle from above;

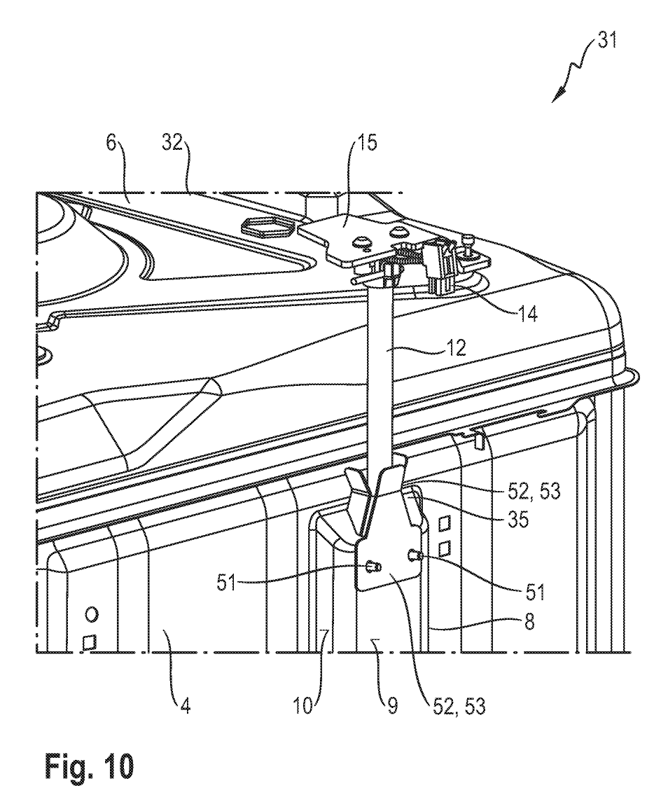

FIG. 10 shows a lateral region of the cooking appliance according to the second exemplary embodiment viewed at an angle from above, said cooking appliance also having a reflector arranged outside the muffle;

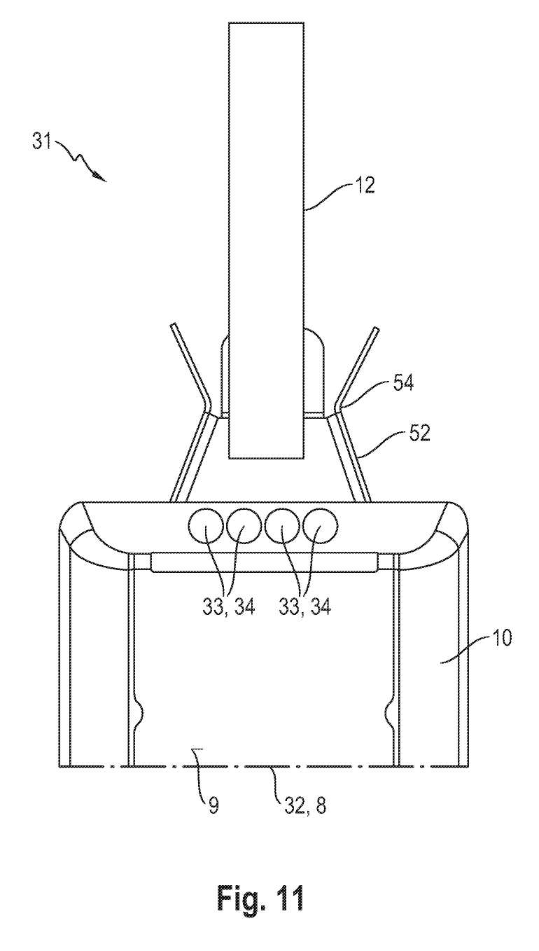

FIG. 11 shows a sectional view from the side of a region of the cooking appliance according to the second exemplary embodiment with the reflector from FIG. 10;

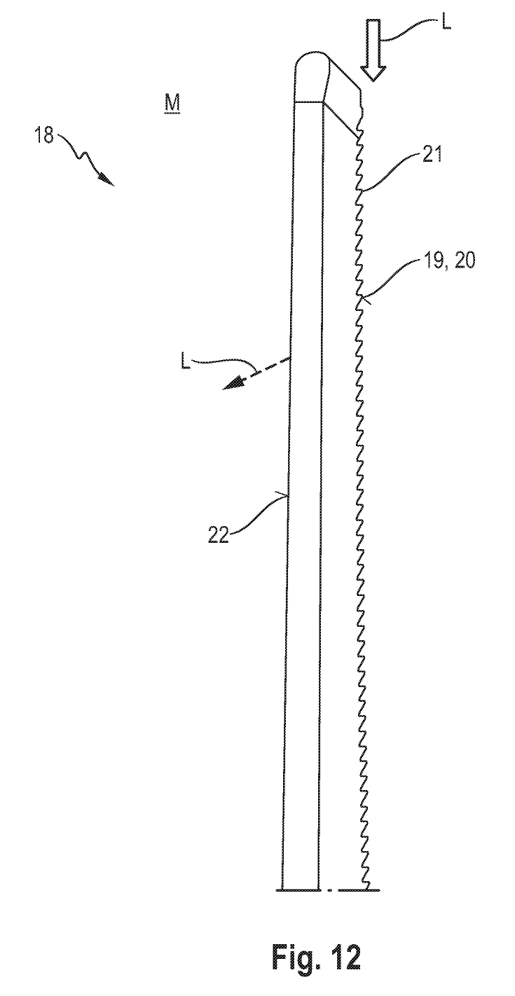

FIG. 12 shows a sectional view from the side of an upper detail of the light-distributing element from FIG. 3;

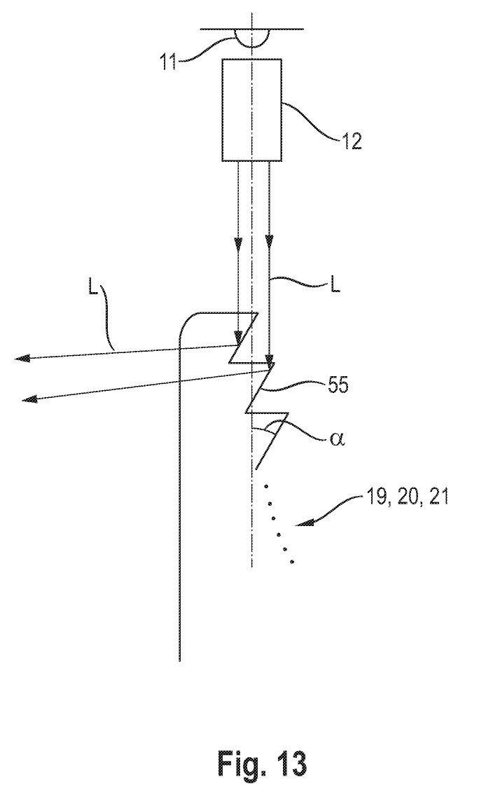

FIG. 13 shows an outline of a sectional view from the side of the light-generating facility and the light-distributing element;

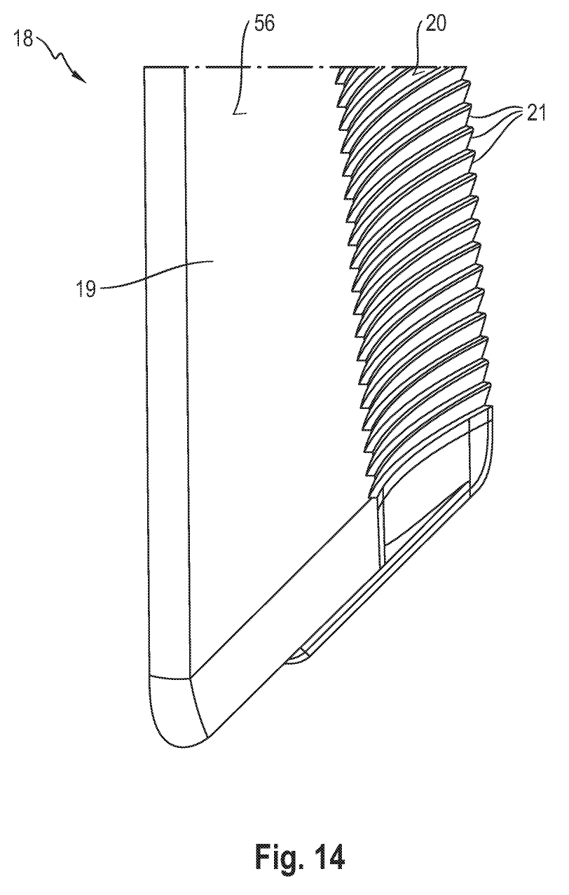

FIG. 14 shows a lower detail of the light-distributing element from FIG. 3 viewed at an angle from the rear;

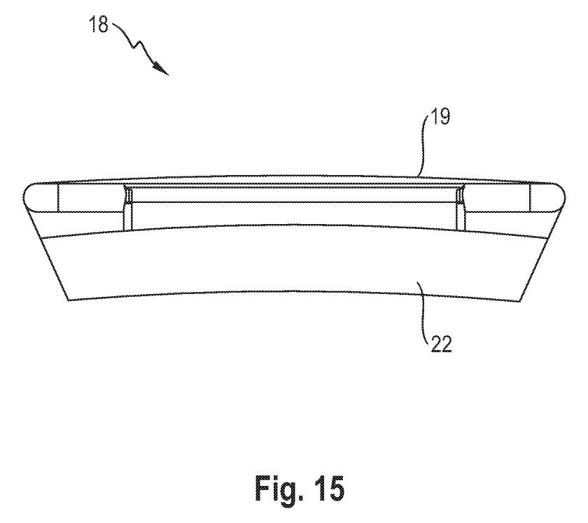

FIG. 15 shows a top view of the light-distributing element; and

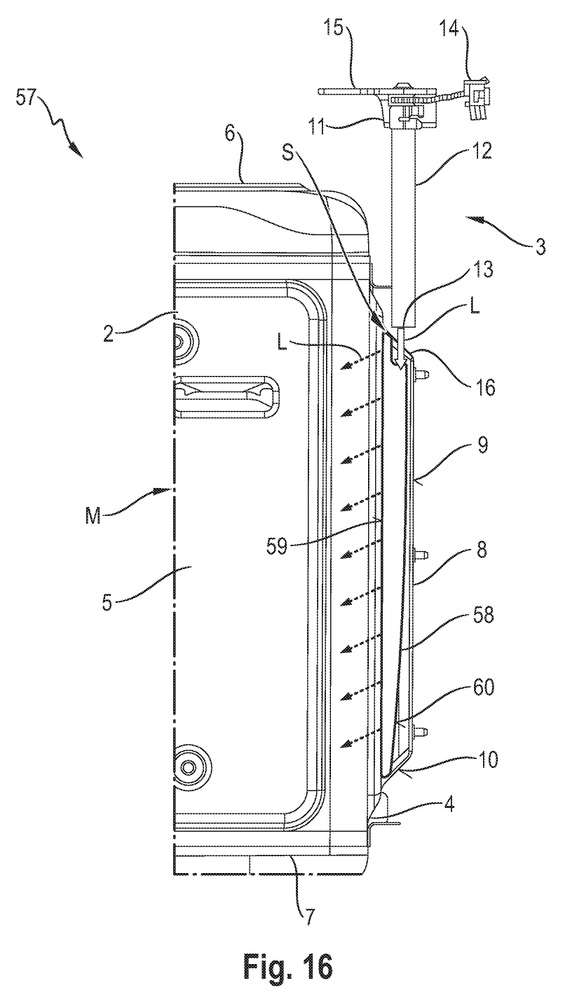

FIG. 16 shows a detail viewed from the side of a muffle of the cooking appliance according to the third exemplary embodiment shown as semi-transparent together with a light-distributing element accommodated in the muffle and a light-generating facility of said cooking appliance.

FIG. 1 shows a side view of different components of a food treatment appliance in the form of a cooking appliance 1, specifically a muffle 2 and a light-generating facility 3. It shows a left-hand side wall 4 and details of a rear wall 5, a top 6 and a base 7 of the metal muffle 2. These walls 4 to 7 of the muffle 2 together delimit a muffle interior M together with right-hand side wall (not shown). The cooking appliance 1 can have an oven functionality, for example in that it has one or more electric heating units (e.g. a top-heating unit, a bottom-heating unit, a hot-air heating unit, etc. (not shown)). Additionally or alternatively the cooking appliance 1 can have a microwave functionality and/or a steam-generating functionality.

The left-hand side wall 4 has a bulge or depression 8 that extends longitudinally in a vertical direction and faces outward. The depression 8 is approximately box-shaped with a top surface 9 extending vertically and an adjoining peripheral side surface 10. The side surface 10 is at an angle to the vertical.

The light-generating facility 3 is arranged above the depression 8 and has one or more light sources in the form of LEDs (not shown), which are accommodated in a light source unit 11 here so that they cannot be seen. The light generated by the LEDs of the light source unit 11 is coupled in at the front of a light-guiding facility in the form of a short bar-shaped light guide 12 made of glass. The light is guided in the light guide 12 and emitted again at an opposing end surface that serves as the light outlet surface 13. An electrical connector 14 and a fastening flap 15 of the light-generating facility 3 are also shown here. The light-generating facility 3 is not fastened directly to the muffle 2.

The light guide 12 ends in front of the side surface 10, in which there is an opening 16 opposite the light outlet surface 13. The light outlet surface 13 is thus at a distance from the opening 16 and not in mechanical contact therewith. The light guide 12 can radiate light through the opening 16 into the muffle interior M, principally or even solely into the associated depression 8. To this end the light guide 12 is aligned vertically so that the main emission direction of the light coupled out or emitted by the light outlet surface 13 is also aligned vertically downward.

FIG. 2 shows the components from FIG. 1 in a view at an angle from above of a left-hand region of the muffle 2. The opening 16 is located in an upper segment 17 of the side surface 10 and is configured here as a large hole incorporated in the upper segment 17. The opening 16 can be covered by a silicone or glass panel 23, in order to prevent the escape of heat and/or vapor and/or steam for example. The large, undivided opening 16 has the advantage that light can pass through practically without loss.

FIG. 3 shows a similar illustration of the cooking appliance 1 to the one in FIG. 1, the muffle 2 now being shown as semi-transparent at least in the region of the depression 8. Located in the depression 8 and therefore also in the muffle interior M is a light-distributing element 18 made of transparent glass for distributing light L, which can be radiated in through the opening 16, into the remainder of the muffle interior M. A gap S is therefore present between the light-generating facility 3 and the light-distributing element 18, the opening 16 being located therein.

The light-distributing element 18 is configured in the manner of an elongated plate and closes an aperture in the depression 8 off from the remainder of the muffle interior M. It can therefore also serve as a cover glass. It is arranged to stand upright, it being possible for a rear face 19 of the light-distributing element 18 to be radiated with the light L radiated in from the opening 16 (“lighting surface”). The light L is deflected by the light-distributing element 18 into the remainder of the muffle interior M (essentially downward at an angle, as shown by the associated dotted arrows). The light-distributing element 18 is therefore an optical transmitted light element. It has a surface structure 21 to deflect the light L at the associating lighting surface 20.

The lighting surface 20 extends with only a slight angle of inclination to the vertical over practically the entire length of the light-distributing element 18, so that the light L from the opening 16 strikes the rear face 19 in a sweeping manner and lights it over practically its entire height. The light-distributing element 18 therefore also emits the light L over its entire length or height at its front face 22. Because the light-distributing element 18 is so long or high that it extends over almost the entire height (i.e. over at least 60%, in particular over at least 75% of the height) of the muffle interior M, a number of insertion levels of the cooking appliance 1 can be lit at the same time, even if a number of inserts are in place.

FIG. 4 shows a view at an angle from above of a lateral region of a muffle 32 of a cooking appliance 31 together with the light-generating facility 3. The cooking appliance 31 differs from the cooking appliance 1 in that there is an opening 33 in the form of a number of (in this instance eight) comparatively small holes 34 on the upper face or in the upper segment 35 of the side surface 36. This opening 33 has the advantage that microwave radiation cannot escape from the muffle 32. There is therefore no need to fit an additional microwave seal. The holes can have a diameter between one and five millimeters for example.

FIG. 5 shows a microwave-proof cover element 41 in the form of a bent perforated sheet with a number of regularly arranged holes 42. The cover element 41 can be placed on the opening 16 of the muffle 2 shown in FIGS. 1 to 3 (from the inside or outside) in order to achieve a particularly high level of modularity. Such a cover element 41 can thus cover the opening 16 as required, then serving as a microwave shield. The cover element 41 has the same advantages as the opening 33 of the cooking appliance 31 and allows the same muffle 2 to be used for cooking appliances 1 with and without microwave function.

The cover element 41 is made of metal and is connected to the depression 8 in an electrically conducting manner. To this end the cover element 41 has four longitudinal holes 43 and 44, which can be used to screw it to the depression 8, as shown in FIG. 6. The cover element 41 can be configured as a metal film, the thickness of which is smaller than a wall thickness of the muffle 2, thereby allowing greater freedom of configuration in respect of the density of the holes 42.

The cover element 41 has flaps 45 bent in the direction of the depression 8 at the edges, in order to achieve elastically resilient and therefore particularly secure positioning on the depression 8.

The cover element 41 can also be implemented in the form of a simpler—for example straight—perforated sheet 46 (as shown during positioning from the inside in FIG. 7) or in the form of expanded sheet. A microwave-proof cover element 41 can also be configured as a metal mesh or metal web.

With the muffle 32 shown as semi-transparent FIG. 8 shows a reflector element accommodated in the depression 8 in the form of a reflector sheet 47. FIG. 9 shows the reflector sheet 47 viewed at an angle from the front. The light-distributing element 18 can be held, for example clamped, in two flap-type upper and lower end regions 48a and 48b. A recess 49 is incorporated in the upper end region 48a to allow the light L to reach the light-distributing element 18. This allows the light L to reach an intermediate space between the light-distributing element 18 and the reflector sheet 47. The reflector sheet 47 allows light radiated onto the inner face of the top surface 9 of the depression to be deflected onto the light-distributing element 18, increasing the light output. The reflector sheet 47 can also have a strip-type reflection region 50 between the end regions 48a and 48b, configured to reflect in a specular or diffuse manner on the muffle side. On the wall side the reflector sheet 47 has a number of bolts 51 (see also Fig. and FIG. 6), which can be guided out through corresponding holes 51a (see also FIG. 7) in the muffle 32 and screwed into place there. This allows the reflector sheet 47 to rest securely on and cover the inner face of the top surface 9.

The reflector sheet 47 can be used in the muffle 2 in a similar manner. In particular the bolts 51 can also then be used to fasten the cover element 41 (see also FIG. 6).

In an alternative development the sheet is not a reflector sheet 47 but just has a mounting function without an essential reflection function (“mounting sheet”).

FIG. 10 shows the components of the cooking appliance 31 shown in FIG. 4 in a view similar to the one in FIG. 4. A funnel-shaped reflector attachment 52 is now also positioned on the muffle 32 and the reflector attachment 52 here is arranged above the opening 33. To this end the reflector attachment 52 is screwed to the top surface 9 of the depression, for example to the bolts 51, by means of a flap-type fastening region 53. The reflector attachment 52 narrows upward from the opening 33 in the direction of the light guide 12, forms an insertion aperture for the light guide 12 at its narrowest point 54 and then widens again, as shown in FIG. 11. The reflector attachment 52 therefore encloses the sides of a spatial region between the light outlet surface 13 of the light guide 12 and the opening 12.

The reflector attachment 52 allows light L, which exits at an angle from the light guide 12 and does not pass directly through the holes 34 into the muffle interior M but is reflected off the enclosing material of the depression 8, to be reflected back onto the opening 33, so that the light output increases. The reflector attachment 52 also serves as an incorporation aid when assembling the light guide 12 and ensures that no insulating material passes between the light guide 12 and the holes 34. This structure is affected by tolerances to a much lesser degree than a long light guide which is fastened to a fan and at the same time is concealed in the muffle 32 (which expands when the temperature increases).

A—for example transparent—cover for example in the form of a steam seal (not shown) can be arranged between the reflector attachment 52 and the muffle 32, being made of silicone or glass for example.

The reflector attachment 52 can also be used with the cooking appliance 1.

FIG. 12 shows a sectional view from the side of an upper detail of the light-distributing element 18. Its rear face 19 has a stepped surface structure 21, while the front face 22 facing the muffle interior M outside the depression 8 is smooth. The front face 22 can be configured as anti-reflective in order to configure the coupling out of light particularly effectively. To this end the front face 22 can be roughened or have an anti-reflection coating. The rear face 19 can also be configured as anti-reflective to couple light in more effectively. The front face 22 can also be provided with a rough surface in order to act as a homogenizing diffuser.

The light L coupled out by the light guide 12 generates a light spot in the region of the surface structure 21. The light spot corresponds to a projection of the incident light beam onto the light-distributing element 18 and the lighting surface 20 also has the surface structure 21. The surface structure 21 has a stepped shape or zig-zag shape in cross section, causing the light L that is incident vertically from above to be emitted in a downward direction at an angle (as shown by the dotted arrow) from the front face 22 into the muffle interior M. This increases the efficiency of the manner in which food present in the muffle interior M is lit.

In order for the light L to be deflected downward at the front, an angle α of an angled sub-region 55 of the stepped surface structure 20 is advantageously 45° or more to a main radiation direction of the light S (in this instance corresponding to the vertical), as outlined in FIG. 13.

FIG. 14 shows a lower detail from the light-distributing element 18 looking toward its rear face 19. Although the surface structure 21 extends over practically the entire height of the rear face 19, it does not need to cover its entire width as well. Instead it only has to be as wide as the light spot so that there can be smooth surface regions 56 in addition to the surface structure 21 (where the lighting surface is also located) on the rear face 19. This simplifies production of the light-distributing element 18.

The light-distributing element 18 can couple the light out homogeneously over its height at the front. To achieve particularly homogeneous lighting, the lighting surface 20 or the surface structure 21 can have a parabolic basic shape or profile along its length (in this instance in the vertical direction). The individual steps are then arranged one behind the other along a parabolic path.

In order to distribute the light L even more effectively—in particular even more homogeneously—the structure can also be bent in the transverse direction, as shown in the top view in FIG. 15.

If individual spatial regions of the muffle interior M are to be lit particularly in a specific manner, for example only spatial regions next to and/or above baking sheets—this can be achieved for example by way of suddenly increasing steps or a zig-zag structure, in which in particular the depth of adjacent steps changes significantly.

FIG. 16 shows a diagram of a cooking appliance 57 similar to the one in FIG. 3 with a light-distributing element 58 accommodated in its muffle 2. The cooking appliance 57 differs from the cooking appliance 1 in the shape and arrangement of the light-distributing element 58 compared with the light-distributing element 18. In the case of the light-distributing element 58 the light L is coupled into an upper edge or narrow face (not by way of the rear face) and coupled out after passing through the light-distributing element 58, over the surface of an optionally also unstructured front face 59 and also distributed over the height. The upper edge of the light-distributing element 58, which serves as a coupling in surface for the light L, is advantageously perpendicular to the incident light L here. A rear face 60 of the light-distributing element 58 can be curved, for example parabolic, in the longitudinal direction (in other words along the vertical direction here), the curvature advantageously being initially flat (in other words deviating little from the vertical) and then becoming steeper (in other words deviating more from the vertical). This allows the light-distributing element 58 to become increasingly narrow in the light radiation direction.

A for example surface-type structure can also be provided on the front face 59 and/or on the rear face 60.

The above cooking appliances 1, 21 and 57 can be configured correspondingly in particular on their right-hand side walls.

The present invention is of course not restricted to the illustrated exemplary embodiment.

The light-generating facility can also radiate its light from below or from the side into the depression and be arranged correspondingly below or to the side of the depression.

A number of light-generating and light-distributing structures can also be present on a side wall, for example a number of light-generating facilities 3, depressions 8 and light-distributing elements 18 or 58, etc.

Generally “one” can refer to a single one or a number, in particular in the sense of “at least one”, “one or more”, etc., unless this is specifically excluded, for example by the expression “just one”, etc.

Also a number can cover both the number specified as well as a standard tolerance range, unless this is specifically excluded.

### LIST OF REFERENCE CHARACTERS

1 Cooking appliance
2 Muffle
3 Light-generating facility
4 Right-hand side wall of muffle
5 Rear wall of muffle
6 Top of muffle
7 Base of muffle
8 Depression
9 Top surface of depression
10 Side surface of depression
11 Light source unit
12 Light guide
13 Light outlet surface
14 Electrical connector
15 Fastening flap
16 Opening
17 Upper segment of side surface
18 Light-distributing element
19 Rear face of light-distributing element
20 Lighting surface
21 Surface structure
22 Front face of light-distributing element
23 Glass panel
31 Cooking appliance
32 Muffle
33 Opening
34 Hole
35 Upper segment
36 Side surface
41 Cover element
42 Hole
43 Longitudinal hole
44 Longitudinal hole
45 Flap
46 Perforated sheet
47 Reflector sheet
48a Upper end region of reflector sheet
48b Lower end region of reflector sheet
49 Recess
50 Reflection region
51 Bolt
51a Hole for bolt
52 Reflector attachment
53 Fastening region
54 Narrowest point of reflector attachment
55 Angled sub-region of stepped surface structure
56 Smooth surface region
57 Cooking appliance
58 Light-distributing element
59 Front face of light-distributing element
60 Rear face of light-distributing element

1-15. (canceled)

16. A food treatment appliance, comprising:
a muffle having a muffle interior;
a light-generating facility arranged outside the muffle for radiating light into the muffle interior through an opening in the muffle; and
a light-distributing element arranged in the muffle interior and configured to distribute light radiating in through the opening,
wherein the light-generating facility and the light-distributing element are arranged such as to define a gap there between.

17. The food treatment appliance of claim 16, wherein the light-generating facility includes a light-guiding facility for guiding the light generated by it to the opening, the light-guiding facility ending in front of the opening and the light-distributing element being accommodated in its entirety in the muffle interior.

18. The food treatment appliance of claim 16, wherein the light-generating facility includes a light-guiding facility for guiding the light generated by it to the opening, the gap being located in its entirety within the muffle interior or in its entirety outside the muffle interior.

19. The food treatment appliance of claim 16, wherein the light-generating facility ends in front of the opening, and further comprising a reflector configured to laterally enclose a region between the light-generating facility and the opening.

20. The food treatment appliance of claim 19, wherein the light-generating facility includes a light-guiding facility for guiding the light generated by it to the opening, said region extending between the light-guiding facility of the light-generating facility and the opening.

21. The food treatment appliance of claim 19, wherein the reflector is connected in a fixed manner to the muffle and has an insertion aperture for the light-generating facility.

22. The food treatment appliance of claim 19, wherein the light-generating facility includes a light-guiding facility for guiding the light generated by it to the opening, said reflector being connected in a fixed manner to the muffle and has an insertion aperture for the light-guiding facility of the light-generating facility.

23. The food treatment appliance of claim 16, further comprising a cover element configured to cover the opening.

24. The food treatment appliance of claim 23, wherein the cover element includes a light-permeable panel or is embodied as a light-permeable panel.

25. The food treatment appliance of claim 23, wherein the cover element is a metal, light-permeable cover element, which is connected in an electrically conducting manner to the muffle.

26. The food treatment appliance of claim 25, wherein the metal, light-permeable cover element is an expanded sheet, a metal mesh or a metal web.

27. The food treatment appliance of claim 16, wherein the muffle has a side wall formed with an outward facing depression, in which the opening is located, said light-generating facility being arranged such as to have a main emission direction which is parallel to the side wall of the muffle.

28. The food treatment appliance of claim 27, wherein the side wall is vertically aligned, said depression having an elongated configuration and being aligned vertically or horizontally in the side wall, said light-distributing element being arranged in the depression.

29. The food treatment appliance of claim 27, wherein the light-distributing element is an optical transmitted light element that shields the depression from a remainder of the muffle interior, said light-distributing element having a face facing away from the muffle interior and having a lighting surface capable of being lit by the light radiated in.

30. The food treatment appliance of claim 29, wherein the lighting structure of the light-distributing element has a stepped surface structure.

31. The food treatment appliance of claim 29, wherein the lighting surface extends at an angle of inclination to a vertical over an entire length of the light-distributing element, so that the light from the opening strikes the face of the light-distributing element in a sweeping manner.

32. The food treatment appliance of claim 16, wherein the light-distributing element has an elongated lighting surface that is curved over a longitudinal extension of the light-distributing element.

33. The food treatment appliance of claim 16, wherein the light-distributing element has an elongated lighting surface that is curved over a transverse extension of the light-distributing element.
